(19) United States
(12) Patent Application Publication
(10) Pub. No.: US 2019/0123600 A1
(43) Pub. Date: Apr. 25, 2019

(54) FLATTENED DC BRUSHLESS MOTOR PUMP

(71) Applicant: Hsia-Yuan HSU, Taichung (TW)

(72) Inventor: Hsia-Yuan HSU, Taichung (TW)

(21) Appl. No.: 15/789,479

(22) Filed: Oct. 20, 2017

(51) Int. Cl. H02K 1/14; H02K 1/02; H02K 7/14; F04D 25/06; F04D 29/22

(52) U.S. Cl. CPC H02K 1/143; H02K 1/02; F04D 29/2238; F04D 25/06; H02K 7/14

(57) ABSTRACT

A flattened DC brushless motor pump is provided. A first part of a silicon steel sheet unit is attached to a first face of a base plate and a second part of the silicon steel sheet unit is wound with a coil unit so that the coil unit does not overlap the height of a blade member of an impeller so as to reduce the length of a shaft of the impeller, such that the height of a base can be reduced to achieve the advantage of flattening. Thus, the flattened DC brushless motor pump can be hidden in a working machine to reduce the space of use.

### FIELD OF THE INVENTION

The present invention relates to a motor pump, and more particularly, to a flattened DC brushless motor pump.

### BACKGROUND OF THE INVENTION

FIG. 1 is an exploded view of a first conventional motor pump. FIG. 2 is another exploded view of the first conventional motor pump. FIG. 3 is a sectional view of the first conventional motor pump. The first conventional motor pump 200 has a main body 210. The main body 210 has a stator chamber 220, a vortex chamber 230, and a shaft chamber 240. The vortex chamber 230 is in communication with the shaft chamber 240. The shaft chamber 240 is provided with a shaft housing 250 in the stator chamber 220. The shaft housing 250 is engaged with a silicon steel sheet unit 260. The silicon steel sheet unit 260 is fitted with two insulating sheets 270. Two coil units 271 are wound between the two insulating sheets 270. The vortex chamber 230 and the shaft chamber 240 are provided with an impeller 280. Through the rotation of the impeller 280, the motor pump 200 is driven to circulate the water. However, a blade member 281 of the impeller 280 overlaps the height of the coil units 271, so it is necessary to lengthen the length of a shaft 282 of the impeller 280. Therefore, the main body 210 cannot be compact, which occupies the space of use.

FIG. 4 is a perspective view of a second conventional motor pump. FIG. 5 is a sectional view of the second conventional motor pump. A second conventional motor pump 300 has a cylindrical silicon steel sheet unit 310, a plurality of coil units 320 disposed in the cylindrical silicon steel sheet unit 310, and an impeller 330 disposed at the middle of the cylindrical silicon steel sheet unit 310. Through the rotation of the impeller 330, the motor pump 300 is driven to circulate the water. However, a blade member 331 of the impeller 330 overlaps the height of the coil units 320, so it is necessary to lengthen the length of a shaft 332 of the impeller 330. Therefore, the motor pump cannot be compact, which occupies the space of use.

Accordingly, the inventor of the present invention has devoted himself based on his many years of practical experiences to solve these problems.

### SUMMARY OF THE INVENTION

The primary object of the present invention is to provide a flattened DC brushless motor pump which has the advantage of being flattened so that the present invention can be hidden in a working machine to reduce the space.

In order to achieve the aforesaid object, the flattened DC brushless motor pump of the present invention comprises a base, a silicon steel sheet unit, and an impeller. The base has a stator chamber and a vortex chamber. The base includes a base plate between the stator chamber and the vortex chamber. The base plate has a first face and a second face corresponding to the stator chamber and the vortex chamber, respectively. The first face of the base plate is provided with a hollow shaft housing. The shaft housing is formed with a shaft chamber at the second face of the base plate. The shaft chamber is in communication with the vortex chamber. The silicon steel sheet unit is disposed in the stator chamber. The silicon steel sheet unit has a first part and a second part. The first part of the silicon steel sheet unit is provided with an engaging trough corresponding to the shaft housing for the silicon steel sheet unit to be secured to the shaft housing. The first part of the silicon steel sheet unit has a contact face attached to the first face of the base plate. The second part is wound with a coil unit. The impeller has a shaft and a blade member which are connected to each other. The shaft is disposed in the shaft chamber. The blade member is disposed in the vortex chamber.

As disclosed in the flattened DC brushless motor pump of the present invention, the first part of the silicon steel sheet unit is attached to the first face of the base plate and the second part of the silicon steel sheet unit is wound with the coil unit so that the coil unit does not overlap the height of the blade member of the impeller so as to reduce the length of the shaft of the impeller, such that the height of the base can be reduced to achieve the advantage of flattening. Thus, the present invention can be hidden in a working machine to reduce the space of use.

### BRIEF DESCRIPTION OF THE DRAWINGS

FIG. 1 is an exploded view of a first conventional motor pump;

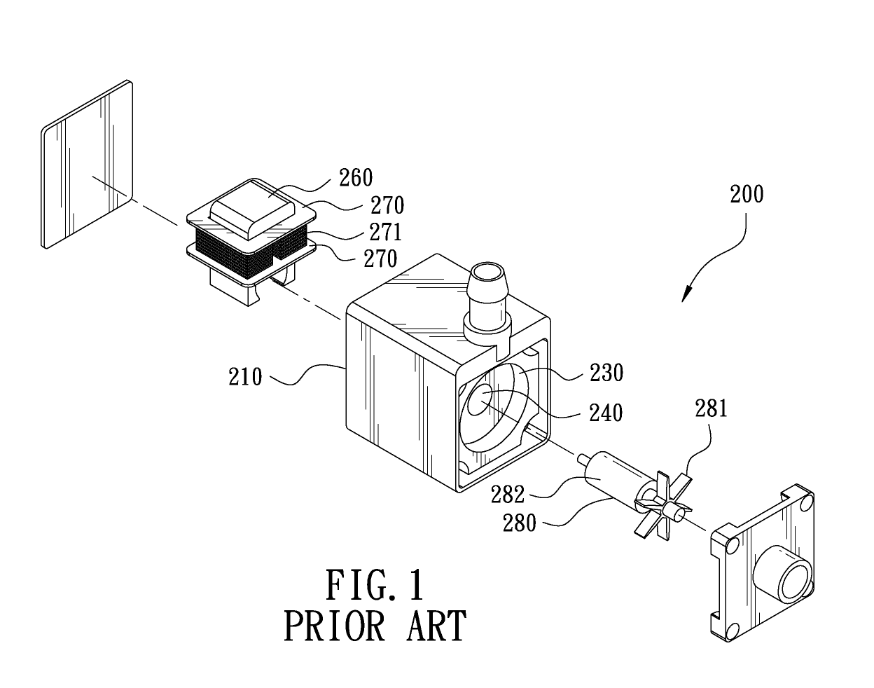

FIG. 2 is another exploded view of the first conventional motor pump;

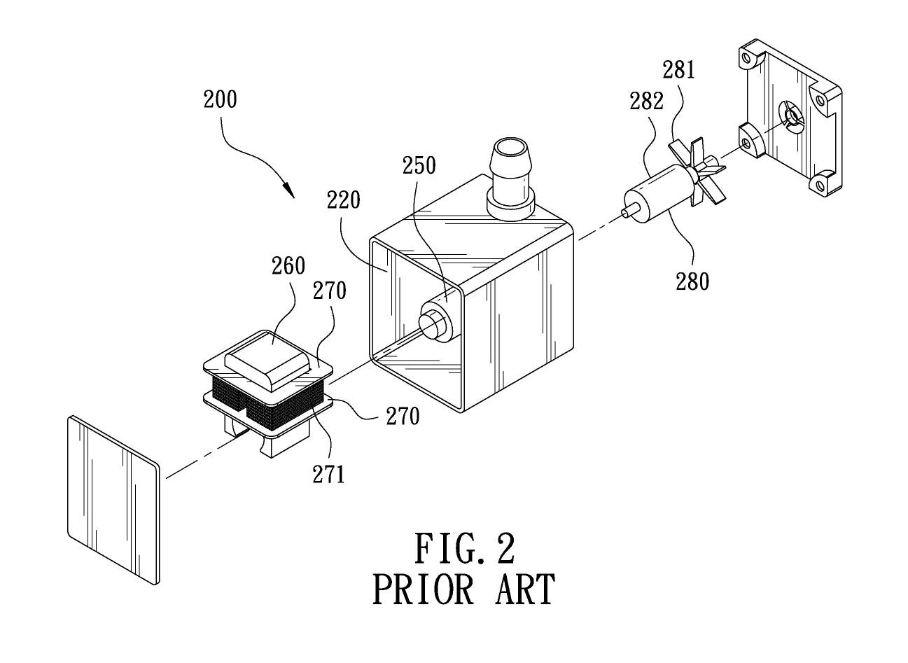

FIG. 3 is a sectional view of the first conventional motor pump;

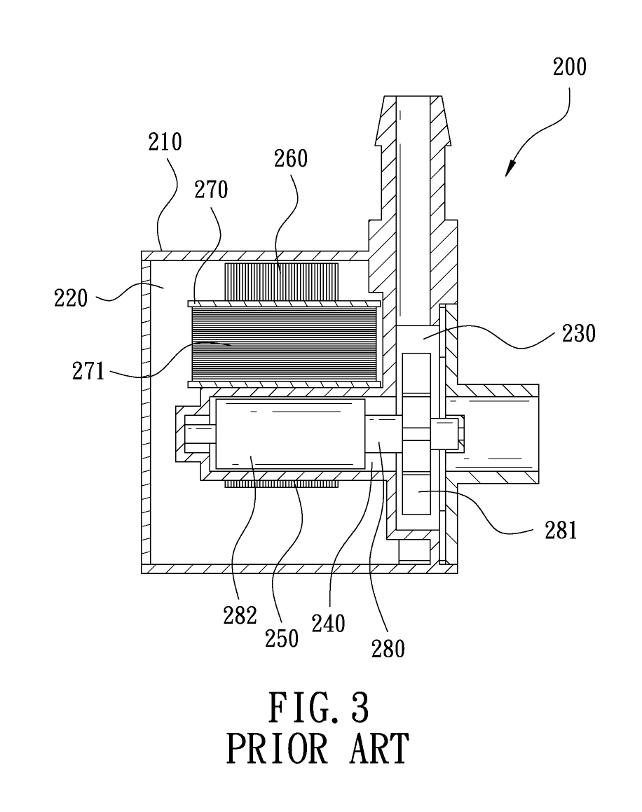

FIG. 4 is a perspective view of a second conventional motor pump;

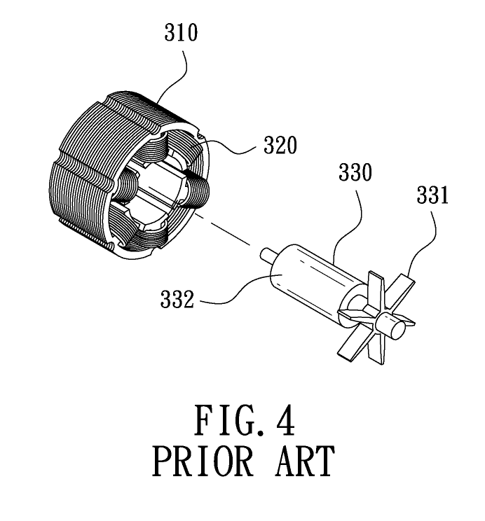

FIG. 5 is a sectional view of the second conventional motor pump;

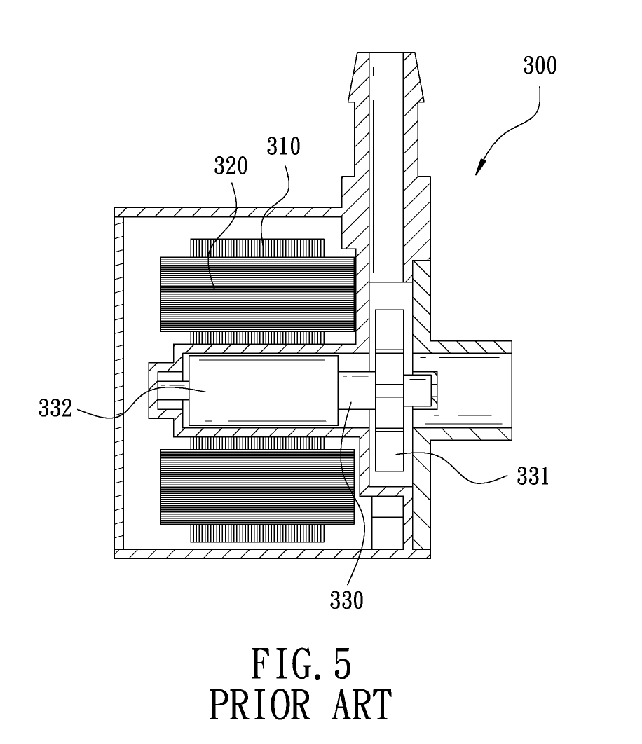

FIG. 6 is an exploded view in accordance with a first embodiment of the present invention;

FIG. 7 is another exploded view in accordance with the first embodiment of the present invention;

FIG. 8 is a sectional view in accordance with the first embodiment of the present invention;

FIG. 9 is a lateral sectional view in accordance with the first embodiment of the present invention;

FIG. 10 is a front sectional view of the silicon steel sheet unit in accordance with a second embodiment of the present invention;

FIG. 11 is a lateral sectional view in accordance with the second embodiment of the present invention;

FIG. 12 is a front sectional view of the silicon steel sheet unit in accordance with a third embodiment of the present invention; and

FIG. 13 is a front sectional view of the silicon steel sheet unit in accordance with a fourth embodiment of the present invention.

### DETAILED DESCRIPTION OF THE PREFERRED EMBODIMENTS

Embodiments of the present invention will now be described, by way of example only, with reference to the accompanying drawings.

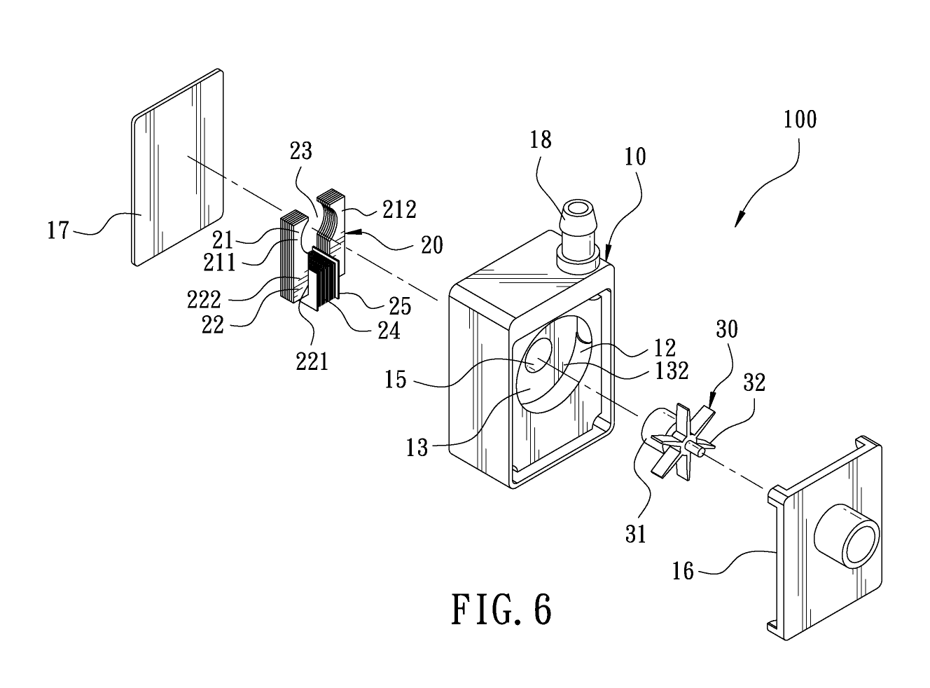

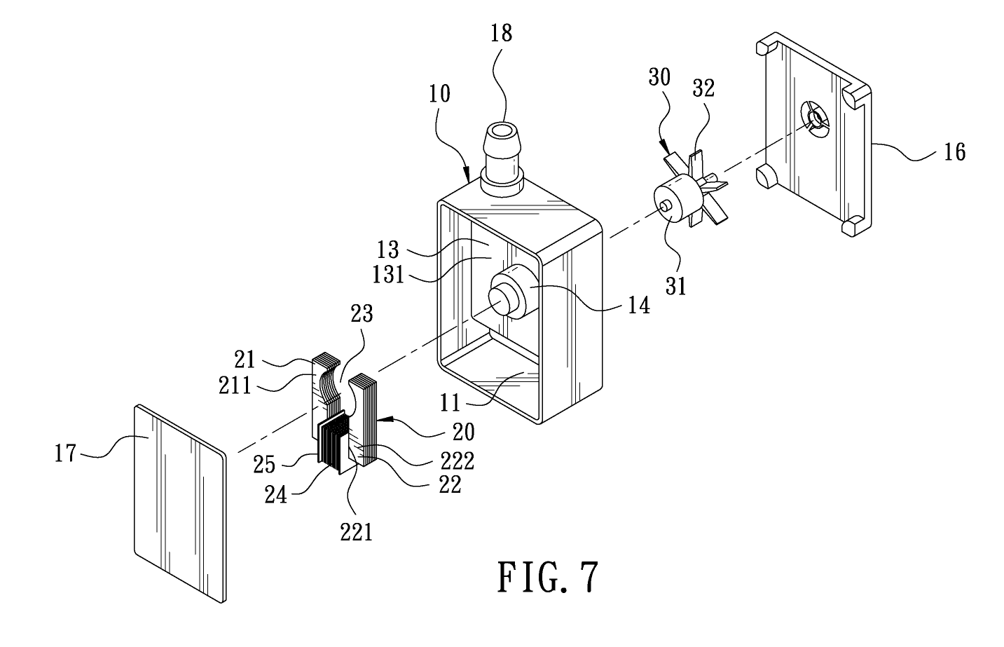

FIG. 6 is an exploded view in accordance with a first embodiment of the present invention. FIG. 7 is another exploded view in accordance with the first embodiment of the present invention. The present invention discloses a flattened DC brushless motor pump 100, which comprises a base 10, a silicon steel sheet unit 20, and an impeller 30.

The base 10 has a stator chamber 11 and a vortex chamber 12. The base 10 includes a base plate 13 between the stator chamber 11 and the vortex chamber 12. The base plate 13 has a first face 131 and a second face 132 corresponding to the stator chamber 11 and the vortex chamber 12 respectively. The first face 131 of the base plate 13 is provided with a hollow shaft housing 14. The shaft housing 14 is formed with a shaft chamber 15 at the second face 132 of the base plate 12. The shaft chamber 15 is in communication with the vortex chamber 12. The base 10 further includes a cover 16 and a cover plate 17. The cover 16 is configured to cover the vortex chamber 12. The cover plate 17 is configured to cover the stator chamber 11. The base 10 is connected with a connector 18.

In this embodiment, the silicon steel sheet unit 20 includes U-shaped silicon steel sheets. The silicon steel sheet unit 20 is disposed in the stator chamber 11. The silicon steel sheet unit 20 has a first part 21 and a second part 22. The second part 22 of the silicon steel sheet unit 20 has an intermediate section 221. Two sides of the intermediate section 221 are connected with extension sections 222, respectively. The first part 21 is provided with a pole shoe section 211 connected with the extension section 222. The pole shoe section 211 is formed with an engaging trough 23 corresponding to the shaft housing 14. The silicon steel sheet unit 20 is secured to the shaft housing 14. The pole shoe section 211 has a contact face 212 attached to the first face 131 of the base plate 13. The intermediate section 221 is wound with a coil unit 24. Two sides of the coil unit 24 are provided with insulating sheets 25.

The impeller 30 has a shaft 31 and a blade member 32 which are connected to each other. The shaft 31 is disposed in the shaft chamber 32. The blade member 32 is disposed in the vortex chamber 12.

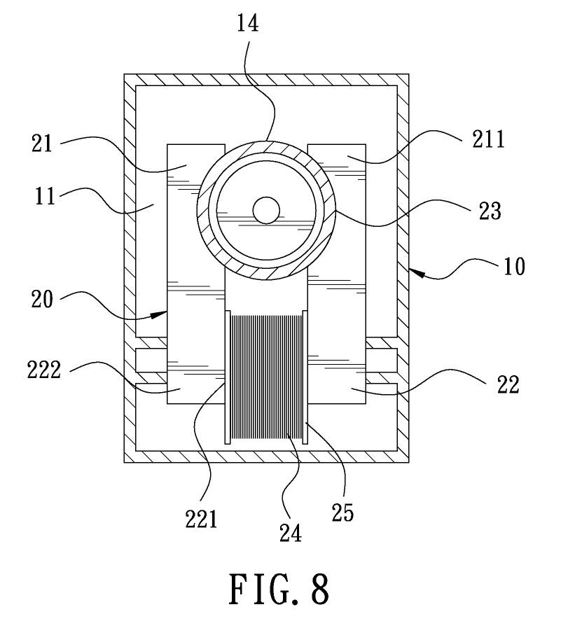

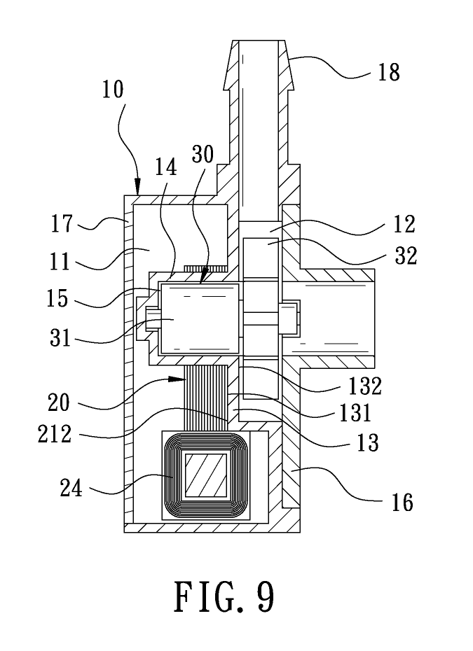

FIG. 8 is a sectional view in accordance with the first embodiment of the present invention. FIG. 9 is a lateral sectional view in accordance with the first embodiment of the present invention. The silicon steel sheet unit 20 is first disposed in the stator chamber 11, and the contact face 212 of the silicon steel sheet unit 20 is attached to the first face 131 of the base plate 13. The shaft 31 of the impeller 30 is disposed in the shaft chamber 15, so that the blade member 32 of the impeller 30 is disposed in the vortex chamber 12. The cover 16 covers the vortex chamber 12 of the base 10. The coil unit 24 is wound around the second part 22 of the silicon steel sheet unit 20, so that the coil unit 24 does not overlap the height of the blade member 32 of the impeller 30 so as to reduce the length of the shaft 31 of the impeller 30. The connector 18 and the second part 22 of the silicon steel sheet unit 20 are disposed at two sides of the base 10 so as not to interfere with each other, such that the height of the base 10 can be reduced to achieve the advantage of flattening. Thus, the flattened DC brushless motor pump 100 of the present invention can be hidden in a working machine to reduce the space of use.

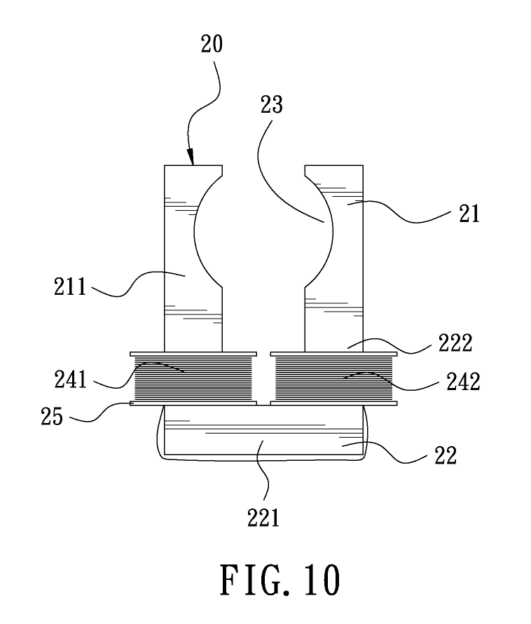

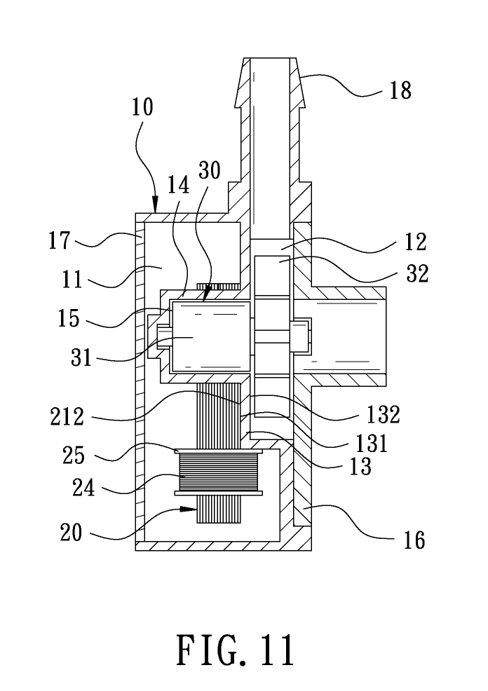

FIG. 10 is a front sectional view of the silicon steel sheet unit in accordance with a second embodiment of the present invention. FIG. 11 is a lateral sectional view in accordance with the second embodiment of the present invention. The second embodiment of the present invention is different from the foregoing first embodiment in that the coil unit 24 includes a first coil unit 214 and a second coil unit 242 which are connected to each other. The first coil unit 214 and the second coil unit 242 are wound around the extension sections 222, respectively

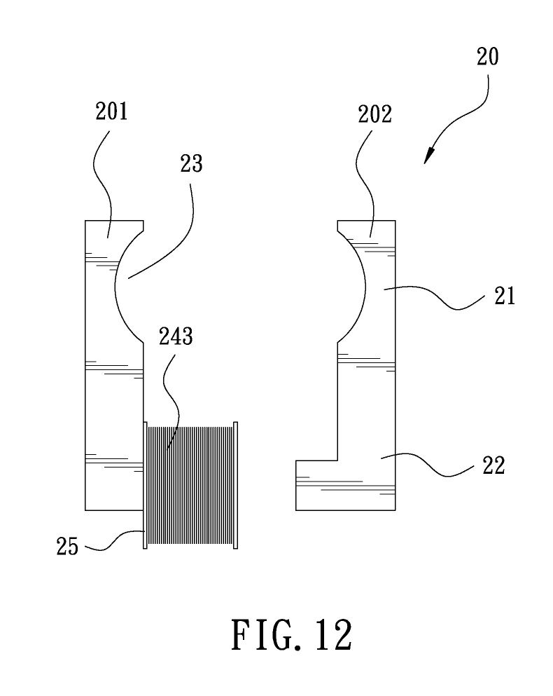

FIG. 12 is a front sectional view of the silicon steel sheet unit in accordance with a third embodiment of the present invention. The third embodiment of the present invention is different from the foregoing first embodiment in that the silicon steel sheet unit 20 includes a first silicon steel sheet unit 201 and a second silicon steel sheet unit 202 which are symmetrical and connected to each other. The first silicon steel sheet unit 201 and the second silicon steel sheet unit 202 each have an L-like shape. The first silicon steel sheet unit 201 is wound with a third coil unit 243.

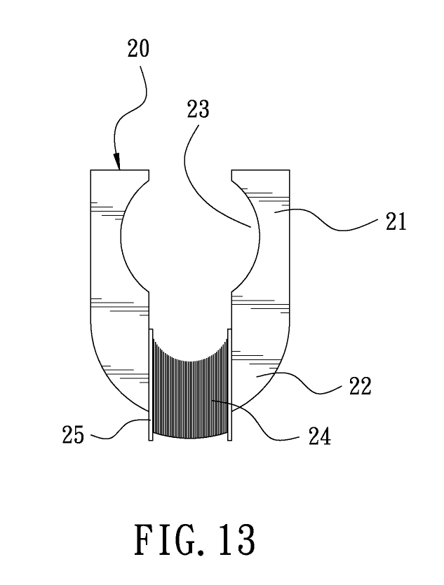

FIG. 13 is a front sectional view of the silicon steel sheet unit in accordance with a fourth embodiment of the present invention. The fourth embodiment of the present invention is different from the foregoing first embodiment in that the silicon steel sheet unit includes C-shaped silicon steel sheets.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A flattened DC (direct current) brushless motor pump, comprising:
a base, having a stator chamber and a vortex chamber, the base including a base plate between the stator chamber and the vortex chamber, the base plate has a first face and a second face corresponding to the stator chamber and the vortex chamber respectively, the first face of the base plate being provided with a hollow shaft housing, the shaft housing being formed with a shaft chamber at the second face of the base plate, the shaft chamber being in communication with the vortex chamber;
a silicon steel sheet unit, disposed in the stator chamber, the silicon steel sheet unit having a first part and a second part, the first part of the silicon steel sheet unit being provided with an engaging trough corresponding to the shaft housing for the silicon steel sheet unit to be secured to the shaft housing, the first part of the silicon steel sheet unit having a contact face attached to the first face of the base plate, the second part being wound with a coil unit; and
an impeller, having a shaft and a blade member which are connected to each other, the shaft being disposed in the shaft chamber, the blade member being disposed in the vortex chamber.

2. The flattened DC brushless motor pump as claimed in claim 1, wherein the silicon steel sheet unit includes C-shaped silicon steel sheets.

3. The flattened DC brushless motor pump as claimed in claim 1, wherein the silicon steel sheet unit includes U-shaped silicon steel sheets.

4. The flattened DC brushless motor pump as claimed in claim 3, wherein the second part of the silicon steel sheet unit has an intermediate section, two sides of the intermediate section are connected with extension sections respectively, and the first part is provided with a pole shoe section connected with a corresponding one of the extension sections.

5. The flattened DC brushless motor pump as claimed in claim 3, wherein the pole shoe section is formed with the engaging trough corresponding to the shaft housing, and the pole shoe section has the contact face attached to the first face of the base plate.

6. The flattened DC brushless motor pump as claimed in claim 4, wherein the coil unit is wound around the intermediate section of the silicon steel sheet unit.

7. The flattened DC brushless motor pump as claimed in claim 4, wherein the coil unit includes a first coil unit and a second coil unit which are connected to each other, and the first coil unit and the second coil unit are wound around the extension sections, respectively.

8. The flattened DC brushless motor pump as claimed in claim 1, wherein the silicon steel sheet unit includes a first silicon steel sheet unit and a second silicon steel sheet unit which are symmetrical and connected to each other, and the first silicon steel sheet unit and the second silicon steel sheet unit each have an L-like shape.

9. The flattened DC brushless motor pump as claimed in claim 8, wherein the first silicon steel sheet unit is wound with a third coil unit.

10. The flattened DC brushless motor pump as claimed in claim 1, wherein the base is connected with a connector, and the connector and the second part of the silicon steel sheet unit are disposed at two sides of the base, respectively.
